(19) United States
(12) Patent Application Publication
(10) Pub. No.: US 2026/0370737 A1
(43) Pub. Date: Nov. 19, 2026

(54) ACCESS TECHNOLOGY AGNOSTIC ACCESS AND MOBILITY MANAGEMENT FUNCTION (AMF) WITH N2/N3 AS SERVICE BASED INTERFACE (SBI) INTERFACES

(71) Applicant: CABLE TELEVISION LABORATORIES, INC., Louisville, CO (US)

(72) Inventors: Omkar Shripad Dharmadhikari, Lakewood, CO (US); Neeharika Jesukumar, Snoqualmie, WA (US); Rahil Gandotra, Boulder, CO (US)

(73) Assignee: CABLE TELEVISION LABORATORIES, INC., Louisville, CO (US)

(21) Appl. No.: 19/681,956

(22) Filed: May 19, 2026

Related U.S. Application Data
(60) Provisional application No. 63/808,012, filed on May 19, 2025.

(51) Int. Cl. H04L 69/08; H04L 67/02

(52) U.S. Cl. CPC H04L 69/08; H04L 67/02

(57) ABSTRACT

Disclosed herein are examples showing the elimination of interworking functions for different radio access technologies to directly interface with the core network (CN). Making N2/N3 interfaces Service Based Interface (SBI)-based by directly implementing Hypertext Transfer Protocol (HTTP)-based functions helps network simplification by enabling unified protocol usage within the CN, and between the radio access network (RAN) and the CN. In an example, an access network (AN) node receives, from a user equipment (UE), a first message. The AN node forwards, to a CN node, the first message directly via an SBI interface using an HTTP protocol. Further, the AN node receives, from the CN node, a second message directly via the SBI interface using the HTTP protocol. The AN node transmits the second message to the UE. In examples, the UE is an RG, a Fifth Generation (5G) RG, a station (STA), or a customer premises equipment (CPE).

### CROSS-REFERENCE TO RELATED APPLICATION

This application claims the benefit of U.S. Provisional Application No. 63/808,012, filed May 19, 2025, the contents of which are incorporated herein by reference.

### BACKGROUND

Currently, the N2 (control-plane)/N3 (user-plane) interfaces between the access network (Third Generation Partnership Project (3GPP) and non-3GPP) and the core network are not Service Based Interfaces (SBIs). These interfaces implement Next Generation Application Protocol (NGAP), which runs over Stream Control Transmission Protocol (SCTP) and General Packet Radio Service (GPRS) Tunneling Protocol for User Plane (GTP-U) protocol, respectively. All other intra-core interfaces are SBI-based and based on Hypertext Transfer Protocol (HTTP) protocol, except the N4 interface between the Session Management Function (SMF) and the User Plane Function (UPF), which implements Packet Forwarding Control Protocol (PFCP), and the N9 interface, which uses GTP-U similar to the N3 interface in Fifth Generation (5G) networks.

5G mobile technology is the next-generation wireless standard, offering faster speeds, lower latency, and increased bandwidth compared to Fourth Generation (4G) mobile technology. 5G is designed to connect people, machines, and objects, enabling various applications like Enhanced Mobile Broadband (eMBB), mission-critical communications, and massive Internet of Things (IoT) deployments. The N2 interface is the reference point between the (Radio) Access Network ((R)AN) and the Access and Mobility Management Function (AMF). The N3 interface is the reference point between the (R)AN and the UPF.

### SUMMARY

One of the key goals of Sixth Generation (6G) mobile technology (the next generation of wireless communication technology, building upon Fifth Generation (5G) mobile technology) is Network Simplification. Implementing a singular Service Based (SB) Hypertext Transfer Protocol (HTTP) protocol across the user and control planes can help achieve that goal. In addition, with a unified protocol implementation, all the Non-Access Stratum (NAS) signaling will no longer be required to traverse the Access and Mobility Management Function (AMF). This will ensure that the AMF is no longer the bottleneck for signaling load and message surges when the network traffic load is high. Also, using a service based interface (SBI) and an HTTP protocol will allow the access network to directly communicate with the individual core network functions (NFs) directly without going through the AMF for all access and mobility management needs. Another advantage of using an SBI and an HTTP protocol is to remove dependency on AMF updates. In comparison, today, because all NAS messages traverse through AMF, any NAS signaling impact associated with a specific NFs also impacts the AMF. This means any enhancements or modifications to the NAS signaling will involve an AMF upgrade and the operators want to move away from the dependency on the AMF upgrade to support any core network enhancements (procedural, feature enhancement, or otherwise).

A main problem being solved by embodiments of the present disclosure is the elimination of interworking functions for different radio access technologies (RATs) to directly interface with the core network, such as the 5G core or the 6G core. Making N2/N3 interfaces SBI-based by directly implementing HTTP-based functions can help with network simplification by enabling unified protocol usage within the core network, and between the radio access network (RAN) and the core network. Furthermore, SBI-based interfaces can enable increased scalability with a Representational State Transfer (RESTful) application programming interface (API) model enabling stateless interactions and increased interoperability with JavaScript object notation (JSON)-based messaging aiding integration of 5G core with non- Third Generation Partnership Project (3GPP) technologies.

In an example, an access network (AN) node receives, from a user equipment (UE), a first message. The AN node forwards, to a core network (CN) node, the first message directly via an SBI interface using an HTTP protocol. Further, the AN node receives, from the CN node, a second message directly via the SBI interface using the HTTP protocol. The AN node transmits the second message to the UE.

In examples, the UE is one or more of an RG, a 5G RG, a station (STA), or a customer premises equipment (CPE). Additionally or alternatively, the CN node is a user plane function (UPF) node, and the SBI interface is an N3 interface.

Additionally or alternatively, the CN node is an AMF node, and the SBI interface is an N2 interface. Additionally or alternatively, the AN node and the CN node communicate using one of: 3GPP access, trusted non-3GPP access, or untrusted non-3GPP access. Additionally or alternatively, the HTTP protocol is one of: an HTTP/2 protocol or an HTTP/3 protocol.

In another example, an AMF node receives, from a first AN node via an SBI-based N2 interface, a first message in a first RAT-specific format. The AMF node translates the first message from the first RAT-specific format into a unified protocol. Further, the AMF node sends, directly to a CN node, the translated first message via an SBI interface using an HTTP protocol. Also, the AMF node receives, directly from the CN node via the SBI interface using the HTTP protocol, a second message in the unified protocol. The AMF node translates the second message from the unified protocol into the first RAT-specific format. Moreover, the AMF node sends, to the first AN node via the SBI-based N3 interface, the translated second message.

Additionally or alternatively, the CN node is a Session Management Function (SMF) node, and the SBI interface using the HTTP protocol is an Nsmf interface. Additionally or alternatively, the first AN node is one of: a 5G-AN node or a 6G-AN node.

Additionally or alternatively, the AMF node and the first AN node communicate using one of: 3GPP access, trusted non-3GPP access, or untrusted non-3GPP access. Additionally or alternatively, the HTTP protocol is one of: an HTTP/2 protocol or an HTTP/3 protocol.

Additionally or alternatively, the first message and the second message are control plane messages.

Additionally or alternatively, the AMF node receives, from a second AN node via an SBI-based N2 interface, a third message in a second RAT-specific format. The AMF node translates the third message from the second RAT-specific format into a unified protocol. Further, the AMF node sends, directly to a CN node, the translated third message via an SBI interface using a HTTP protocol. Also, the AMF node receives, directly from the CN node via the SBI interface using the HTTP protocol, a fourth message in the unified protocol. The AMF node translates the fourth message from the unified protocol into the second RAT-specific format. Moreover, the AMF node sends, to the second AN node via the SBI-based N2 interface, the translated fourth message.

Additionally or alternatively, the first AN node is a 3GPP AN node, and the second AN node is an untrusted non-3GPP AN node. Alternatively, the first AN node is an untrusted non-3GPP AN node, and the second AN node is a 3GPP AN node.

In a further example, a UPF node receives from an AN node via an SBI-based N3 interface, a first message in a RAT-specific format. The UPF node translates the first message from the RAT-specific into a unified protocol. Further, the UPF node sends, directly to a CN node, the translated first message via an SBI interface using an HTTP protocol. Also, the UPF node receives, directly from the CN node via the SBI interface using the HTTP protocol, a second message in the unified protocol. The UPF node translates the second message from the unified protocol into the RAT-specific format. Moreover, the UPF node sends, to the first AN node via the SBI-based N3 interface, the translated second message.

Additionally or alternatively, the CN node is a protocol data unit (PDU) session anchor (PSA)-UPF, the SBI interface using the HTTP protocol is an SBI-based N9 interface, and the first message and the second message are user plane messages. Additionally or alternatively, the first AN node is one of: a 5G-AN node or a 6G-AN node. Additionally or alternatively, the UPF node and the first AN node communicate using one of: 3GPP access, trusted non-3GPP access, or untrusted non-3GPP access. Additionally or alternatively, the HTTP protocol is one of: an HTTP/2 protocol or an HTTP/3 protocol.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1 is an illustration of an example device;

FIG. 2 illustrates an example communication system;

FIG. 3 illustrates an example of a functional split between a next generation radio access network (NG-RAN) and Fifth Generation (5G) core (5GC);

FIG. 4 illustrates an example of a protocol stack for a user plane and a control plane;

FIG. 5 illustrates an example of 5G architecture, including a 5GC;

FIG. 6 illustrates an example of interfaces for the control plane for 5G-New Radio (5G-NR) access in 5G;

FIG. 7 illustrates an example of interfaces for the proposed control plane for 5G-NR access in the Sixth Generation (6G) and beyond;

FIG. 8 illustrates an example of interfaces for the user plane for 5G-NR access in 5G;

FIG. 9 illustrates an example of interfaces for the control plane for non-3GPP access in 5G;

FIG. 10 illustrates an example of interfaces for the proposed control plane for non-Third Generation Partnership Project (3GPP) access in 6G and beyond;

FIG. 11 illustrates an example of interfaces for the proposed control plane for 6G access and non-3GPP access in 6G and beyond; and

FIG. 12 illustrates an example of interfaces for the proposed user plane for 6G access and non-3GPP access in 6G and beyond.

### DETAILED DESCRIPTION

Examples and embodiments are provided herein include a network function that can dynamically support various radio access technologies (RATs), including Third Generation Partnership Project (3GPP) and non-3GPP access networks, without requiring interworking functions. In prior applications, the interworking functions add complications and operation inefficiencies/inflexibility and hinder adoption of Fifth Generation (5G) mobile technology. In contrast, the network function provided herein automatically adapts to new access types with minimal configuration adjustments.

One aspect of the present examples and embodiments provides a method that allows the Access and Mobility Management Function (AMF) to directly interface with non-3GPP access networks (e.g., Wi-Fi) over standard service-based interfaces (SBIs), utilizing N1 and N2 interfaces without interworking function requirements.

Another aspect of the present examples and embodiments is to provide a unified protocol adaptation and signaling translator in the AMF that automatically translates signaling from multiple RAT-specific formats (e.g., Long-Term Evolution (LTE) Non Access Stratum (NAS), New Radio (NR) NAS, or Wi-Fi signaling) into a standard protocol for consistent session management.

It is one aspect of the present examples and embodiments to provide a system within AMF that dynamically adjusts Quality of Service (QoS) settings and maintains uniform service levels across different RATs, enabling seamless transition and QoS continuity across sessions using multiple access networks.

Another aspect of the present examples and embodiments is to deploy an AMF at the network edge to reduce latency and handle service requests from multiple access technologies, with capabilities for service continuity and low-latency applications in Internet of Things (IoT) and ultra-reliable low latency (URLLC). Additionally or alternatively, examples and embodiments herein deploy one or more access and mobility management functions at the network edge, reducing latency and handle service requests from multiple access technologies. These functions may be performed by one or more network entities or nodes.

It is one aspect of the present examples and embodiments to provide a central repository integrated within the AMF that maintains subscriber information, policies, and session details uniformly across access networks, supporting cross-RAT data consistency and session continuity.

Another aspect of the present examples and embodiments is to provide a system that supports network slicing across both 3GPP and non-3GPP RATs, enabling the creation and management of slices that span heterogeneous access networks, enhancing service continuity for applications spanning multiple RATs.

Further, examples and embodiments provided herein help aid convergence, which is highly important to the cable companies that are multiple system operators (MSOs) owning a hybrid infrastructure with wired deployments (e.g., optical, fiber, coax), wireless deployments with Wi-Fi (e.g., home, public and carrier grade) and cellular deployments (e.g., Fourth Generation (4G), 5G, Sixth Generation (6G), and beyond).

One aspect of the present examples and embodiments is to provide a mechanism within an AMF that manages different authentication methods (e.g., Extensible Authentication Protocol (EAP)-based, Subscriber Identity Module (SIM)-based, certificate-based, and so forth) dynamically based on the RAT being used, without requiring specific authentication intermediaries or interworking functions.

Another aspect of the present examples and embodiments is to replace existing Stream Control Transmission Protocol (SCTP) used for N2 and support seamless, stateless, and Hypertext Transfer Protocol (HTTP)/2-based communication (or HTTP/3) to align with other SBI protocols. This enables better support for microservices, stateless communication, and flexible resource management.

It is one aspect of the present examples and embodiments to provide a Representational State Transfer (RESTful) application programming interface (API) structure for N2 interactions to support scalable and modular communication among control plane functions. This scalable and modular communication among control plane functions provides a new outlook at envisioning an efficient architecture moving from 5G to 6G and beyond.

Another aspect of the present examples and embodiments is to restructure current procedures (e.g., registration, handover, and bearer management) into discrete services. Each service would have defined APIs to enable modular interactions and allow flexibility in integrating network functions (NFs).

Another aspect of the present examples and embodiments is to provide a control plane to use consistent data models and schemas for status updates, User Equipment (UE) context information, and handover data across N2, aligning with service-based principles for efficient integration with other NFs.

One aspect of the present examples and embodiments is to redefine policy control elements on the N2 interface to fit into an API-driven model. In examples provided herein, policies are managed and enforced through a common framework compatible with other SBIs.

Examples and embodiments provided herein include context-sharing protocols to allow NFs (like the AMF and Session Management Function (SMF)) to seamlessly share session details, user information, and mobility status with N2-enabled services.

Numerous additional features and advantages of the embodiment and examples provided herein will become apparent to those skilled in the art upon consideration of the descriptions provided herein below. Examples and embodiments of methods and procedures provided herein may be used in example devices and systems provided below.

The underlying principle of a communication system is to enable one or more devices to communicate with one or more other devices. At a basic level, any device referenced herein (including a virtual and/or physical hardware platform configured to execute software and/or one or more functions) may be understood to include, for example, one or more processors and/or processing circuitry, memory and/or storage, one or more communication interfaces (e.g., one or more transceivers which may or may not be integrated with the processor), one or more antennas and/or antenna arrays, one or more inputs (e.g., microphone, keyboard, mouse, sensor input), one or more outputs (e.g., a display, a touchscreen, a port, a speaker), a power source, timing circuitry (e.g., one or more clocks), and/or positioning circuitry (e.g., GNSS such as GPS and/or GLONASS). In some examples, a device may include identity and/or security circuitry (e.g., a SIM, eSIM, secure element, trusted execution environment). These components may be operably connected to one another via any suitable direct and/or indirect coupling (e.g., buses, interconnects, and/or one or more intermediate components).

A UE may be interchangeable with a station (STA), a mobile station, a fixed or mobile subscriber unit, a subscription-based unit, a pager, a cellular telephone, a personal digital assistant (PDA), a smartphone, a laptop, a netbook, a computer, a server, a functional entity (e.g., virtual and/or physical) a wireless sensor, a hotspot or Mi-Fi device, an Internet of Things (IoT) device, a watch or other wearable, a head-mounted display (HMD), a vehicle, a drone, or the like. In some examples, a UE may be a reduced-capability device, an industrial controller, a sensor/actuator node, a customer premises equipment (CPE), a fixed wireless access (FWA) terminal, an extended reality (XR) device, and/or a sidelink-capable device configured for device-to-device communications.

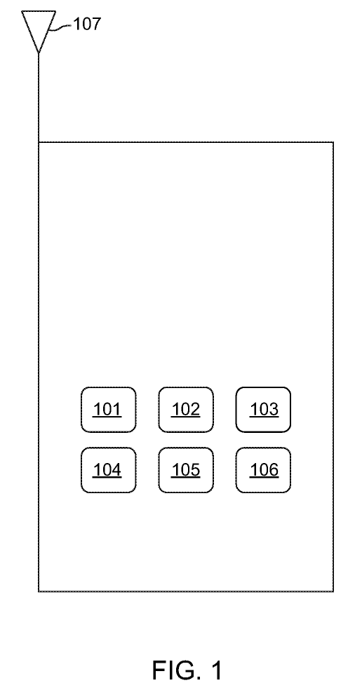

FIG. 1 is an illustration of an example device. In one case, the device may be a UE suited for mobile operation. In this example, the UE may have a processor 101, a transceiver 102, a touchscreen 103, a power source 104 (e.g., a battery), a GPS 105, one or more other components 106 (e.g., as described herein), and/or an antenna 107.

Generally, a processor may be any kind of processor, such as a processor capable of carrying out one or more of the techniques described herein. A transceiver may be configured to transmit and receive signals. In one case, there may be a separate receiver and transmitter. A transceiver may be connected to one or more antennas (e.g., MIMO technology). A transceiver may be configured to transmit RF signals. In one case, a transceiver may be configured to transmit light signals (e.g., IR, UV, laser, etc.). A transceiver may be configured to send/receive more than one type of RF signal (e.g., different radio access technologies for one transceiver, or multiple transceivers each dedicated to a specific radio access technology). A transceiver may be configured to modulate signals for transmission and demodulate signals for reception. The UE may support half-duplex and/or full-duplex operation. In some examples, transmission and reception of some or all signals may be concurrent, overlapping, and/or separated in time and/or frequency (e.g., using FDD, TDD, supplemental uplink/downlink, and/or other duplexing arrangements). In some examples, the transceiver and/or antenna system may support beamforming (e.g., analog, digital, and/or hybrid beamforming), beam management, and/or operation using multiple antenna panels.

Different radio access technologies may be used with one or more transceivers (e.g., IEEE 802.11 variants including 802.11a/b/g/n/ac/ax/be, WCDMA, CDMA2000, GSM, LTE/E-UTRA, LTE-A, NR, and/or other wireless access technologies). In some examples, a device may additionally or alternatively support short-range and/or personal-area technologies (e.g., Bluetooth, IEEE 802.15.4/Zigbee/Thread, UWB), and/or non-terrestrial and/or satellite access technologies.

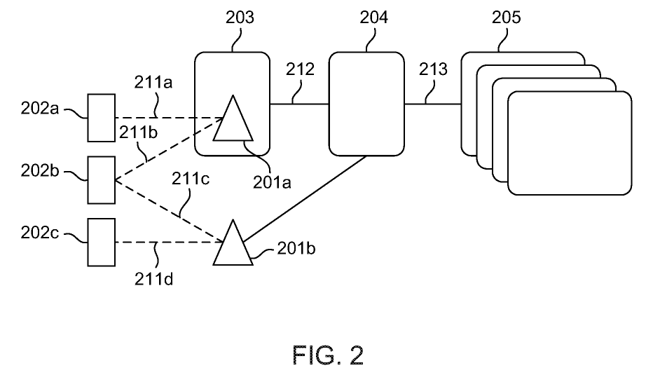

FIG. 2 illustrates an example communication system. This example may be used to illustrate multiple wireless protocols. For all wireless protocols, there may be mobile or stationary devices (e.g., 202a, 202b, 202c, such as a UE) that connect to a base station device 201a and/or 201b. In one case, this may enable a mobile device to connect to a service (e.g., a remote server) or data network (e.g., internet).

In one case, the base stations (201a, 201b) may be equivalent to, and/or interchangeable with, a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, transmission receive point (TRP), network (NW), reception point (RP), radio remote head (RRH), distributed antenna (DA), base station (BS), a sector (of a BS), and a cell (e.g., a geographical cell area served by a BS). Each base station may be representative of more than one base station (e.g., multiple transmission reception points). Each base station may be representative of more than one base station (e.g., multiple transmission reception points). In some examples, a base station may be implemented as one or more disaggregated and/or virtualized functional entities (e.g., one or more of a central unit (CU), distributed unit (DU), and/or radio unit (RU)), which may be co-located and/or separated and interconnected via fronthaul and/or midhaul. In some examples, a base station may be terrestrial or non-terrestrial (e.g., satellite, airborne, and/or high-altitude platform based), and the air interface 211a–211d may correspondingly include terrestrial and/or non-terrestrial links.

A base station may be a network node. Other network nodes may be located in a network, including the core network. A network node may communicate over a wired connection, over a wireless connection, or over both. A network node may include a processor and a communication interface. A network node may be or may include a network function (NF). Further, a base station may include a processor, a transceiver, and a further communication interface. The further communication interface may be used for communications between the base station and nodes in the core network (or core network nodes).

Generally, a communication system may use a combination of wired and wireless connections at different points in the system. One or more wireless technologies may employ, for example, channel access and/or multiple access techniques including CDMA, TDMA, FDMA, OFDMA, SC-FDMA, spatial-division multiple access (SDMA), non-orthogonal multiple access (NOMA), rate-splitting multiple access (RSMA), and/or other access techniques. In some examples, a wireless interface may employ one or more multicarrier and/or single-carrier waveforms (e.g., OFDM, DFT-s-OFDM, FBMC, and/or other waveforms), and may employ filtering/windowing or other spectrum-shaping approaches.

A base station may be configured to transmit and/or receive wireless signals on one or more carrier frequencies, which may be referred to as a cell (not shown). A base station (201a, 201b) may communicate with one or more UEs (202a, 202b, 202c) over an air interface (211a, 211b, 211c, 211d).

In one case, one or more base stations may implement LTE radio access and NR radio access together, for instance using dual connectivity (DC) approach, carrier aggregation, interworking, and/or other multi-RAT mechanisms. Therefore, the system (e.g., and perhaps one or more UEs) may implement multiple types of radio access technologies that use more than one type of base station (e.g., an eNB and a gNB).

In one case, the communication system may include a radio access network (RAN) 203, a core network (CN) 204, and one or more other elements represented by 205 (e.g., the public switched telephone network (PSTN), the Internet, and/or other networks).

In one scenario using FIG. 2 as an illustration, the RAN 203 may be in communication with a CN 204. In this scenario, the base station 201a may be an eNB and the access technology may be based on E-UTRA (e.g., LTE, LTE-Advanced, and/or related evolutions). The communication system may handle data transmission associated with a UE 202a, where different traffic flows may have different requirements (e.g., throughput, latency, reliability, error tolerance, mobility, and/or priority). In some examples, the CN 204 may include, or be coupled to, one or more packet core functions (not shown) such as mobility management, session/bearer management, user-plane gateways, policy functions, subscriber data functions, billing, and/or authentication functions (e.g., in an Evolved Packet Core (EPC) implementation). In some examples, the eNB may communicate with other base stations via an inter-base-station interface (e.g., an X2 interface or analogous interface) and may perform radio resource management, scheduling, and/or mobility operations.

In one scenario using FIG. 2 as an illustration, the RAN 203 and the CN 204 may employ NR radio access technologies and related protocols. The base station may be a gNB 201. The gNB(s) may implement carrier aggregation technology, where multiple component carriers may be transmitted to the UE 202a. A subset of these component carriers may be on unlicensed spectrum while the remaining component carriers may be on licensed spectrum. The UE(s) may communicate with the gNB(s) using transmissions associated with a scalable numerology (e.g., subcarrier spacing, etc.). For example, the OFDM symbol spacing and/or OFDM subcarrier spacing may vary for different transmissions, different cells, and/or different portions of the wireless transmission spectrum. The UE(s) may communicate with gNB(s) using subframe or transmission time intervals (TTIs) of various or scalable lengths (e.g., containing a varying number of OFDM symbols and/or lasting varying lengths of absolute time). In some examples, the gNB(s) and/or UE(s) may support beam-based operation (e.g., in millimeter-wave spectrum), multi-TRP transmission/reception, integrated access and backhaul (IAB), positioning, and/or operation in licensed, unlicensed, and/or shared spectrum. The gNB(s) may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards the User Plane Function (UPF), routing of control plane information towards the AMF, and the like. The gNB(s) may communicate with one another over an Xn interface.

In one scenario using FIG. 2 as an illustration, the base station device 201a and/or 201b may comprise an access point (AP) implementing a wireless local area network (WLAN) radio access technology (e.g., IEEE 802.11). One or more devices 202a–202c may comprise stations (STAs) that associate with the AP to communicate over an air interface (e.g., 211a–211d). The AP may provide access to one or more networks 205 via a distribution system (DS) and/or backhaul 213 (e.g., Ethernet and/or wireless backhaul). In some examples, the WLAN may support operation in multiple bands (e.g., 2.4 GHz, 5 GHz, and/or 6 GHz), and may employ OFDM/OFDMA, multi-user MIMO, scheduling, and/or other medium access features. In some examples, a STA and AP may support multi-link operation (MLO) in which communications are coordinated over multiple links (e.g., across different bands and/or channels) to improve latency, throughput, reliability, and/or robustness.

Not shown (e.g., but still possibly part of one or more example scenarios described herein), the CN may include one or more AMF, one or more UPF, one or more SMF, and/or one or more Data Networks (DNs). In one case, the aforementioned elements may be owned and/or operated by an entity other than the CN operator.

In one scenario using FIG. 2 as an illustration, an Internet 205 may include a global system of interconnected computer networks and devices that use common communication protocols, such as the transmission control protocol (TCP), user datagram protocol (UDP) and/or the internet protocol (IP) in the TCP/IP internet protocol suite.

In some examples, a UE 202 may comprise an IoT device and/or machine-type communication (MTC) device, which may have constraints and/or design targets different from a handheld smartphone (e.g., reduced bandwidth capability, reduced antenna count, reduced peak data rate, extended coverage operation, low cost, and/or low power consumption). In some examples, an IoT device may communicate using periodic, event-driven, and/or sporadic transmissions and may employ power-saving techniques (e.g., sleep cycles, extended discontinuous reception, paging-related power saving, and/or other power management). In some examples, IoT communications may be supported via cellular RATs (e.g., LTE-based IoT and/or NR-based reduced capability devices) and/or via non-cellular RATs (e.g., WLAN, Bluetooth, IEEE 802.15.4), including via an IoT gateway device.

In some examples, IoT devices and/or reduced-capability devices may be supported as part of one or more standardized evolutions of cellular systems.

In some examples, the communication system may be compatible with, and/or evolve toward, 6G systems, including systems aligned with an IMT‑2030 framework and/or other future IMT frameworks. In such examples, a UE and/or network node may support one or more enhancements such as operation using additional spectrum ranges (e.g., including higher-frequency bands), tighter integration of communications with sensing and/or positioning, AI/ML-assisted adaptation and/or automation of air interface and network operations, and/or integration of terrestrial and non-terrestrial access (e.g., satellite and/or high-altitude platforms). These examples are non-limiting and are intended to encompass analogous features in present and future wireless systems.

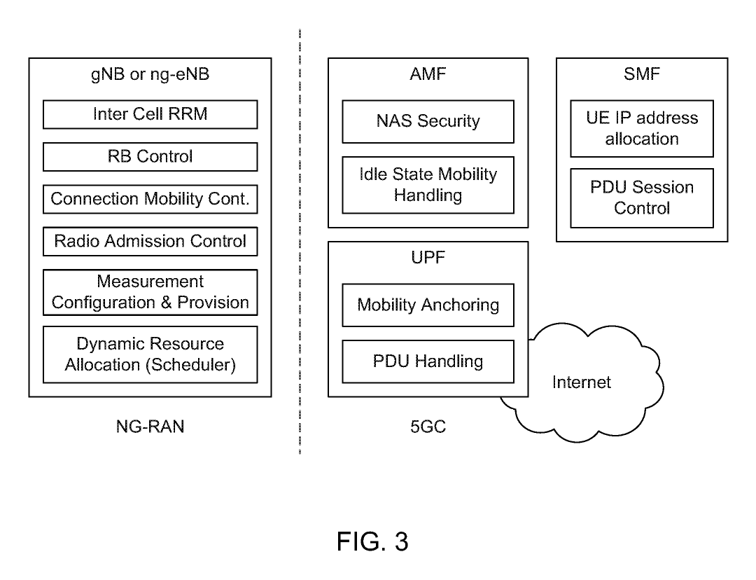

FIG. 3 illustrates an example of a functional split between the NG-RAN and 5GC. The AMF may be connected to one or more gNBs of the RAN via an N2 interface and may serve as a control node. For example, the AMF may be responsible for authenticating a UE’s support for network slicing (e.g., handling of different protocol data unit (PDU) sessions with different requirements), selecting a particular SMF, management of the registration area, termination of non-access stratum (NAS) signaling, mobility management, and the like. Network slicing may be used by the AMF in order to customize CN support for one or more UEs based on the types of services being utilized by the respective UE. For example, different network slices may be established for different use cases such as services relying on URLLC access, services relying on enhanced massive mobile broadband (eMBB) access, services for MTC access, and the like. The AMF may provide a control plane function for switching between the RAN and other RANs that employ other radio technologies (e.g., as described herein). The SMF may be connected to an AMF in the CN via an N11 interface. The SMF may also be connected to a UPF in the CN via an N4 interface. The SMF may select and control the UPF and configure the routing of traffic through the UPF. The SMF may perform other functions, such as managing and allocating UE IP address, managing PDU sessions, controlling policy enforcement and QoS, providing DL data notifications, and the like. A PDU session type may be IP-based, non-IP based, Ethernet-based, and the like. The UPF may be connected to one or more gNB in the RAN via an N3 interface, which may provide a UE with access to packet-switched networks, such as the Internet, to facilitate communications between one or more UEs and IP-enabled devices. The UPF may perform other functions, such as routing and forwarding packets, enforcing user plane policies, supporting multi-homed PDU sessions, handling user plane QoS, buffering DL packets, providing mobility anchoring, and the like. The CN may facilitate communications with other networks. For example, the CN may provide a UE with access to the other networks 212, which may include other wired and/or wireless networks that are owned and/or operated by other service providers. In one example, the UEs may be connected to a local DN through a UPF via an N3 interface to the UPF and an N6 interface between the UPF and the DN. As discussed herein, a NR RAN may be called an NG-RAN and a NR CN may be called a 5GC.

Generally, in a 5G RAN, there may be several interfaces that connect the UE, radio units, and the 5G Core to ensure proper control and data flow. The Uu interface is the 5G New Radio (NR) air interface between the UE and the gNB, enabling over-the-air transmission of control signaling and user data. Within the gNB, the F1 interface is used between the Central Unit (CU) and the Distributed Unit (DU); it is split into F1-C for control-plane signaling and F1-U for user-plane data transfer. When the CU itself is disaggregated, the E1 interface connects the CU-Control Plane (CU-CP) and the CU-User Plane (CU-UP), allowing independent scaling and deployment of control and user functions. Toward the 5G Core, the N2 interface links the gNB to the AMF, carrying control-plane signaling related to registration, mobility, and session management, while the N3 interface connects the gNB to the UPF and transports user-plane traffic between the RAN and the core network.

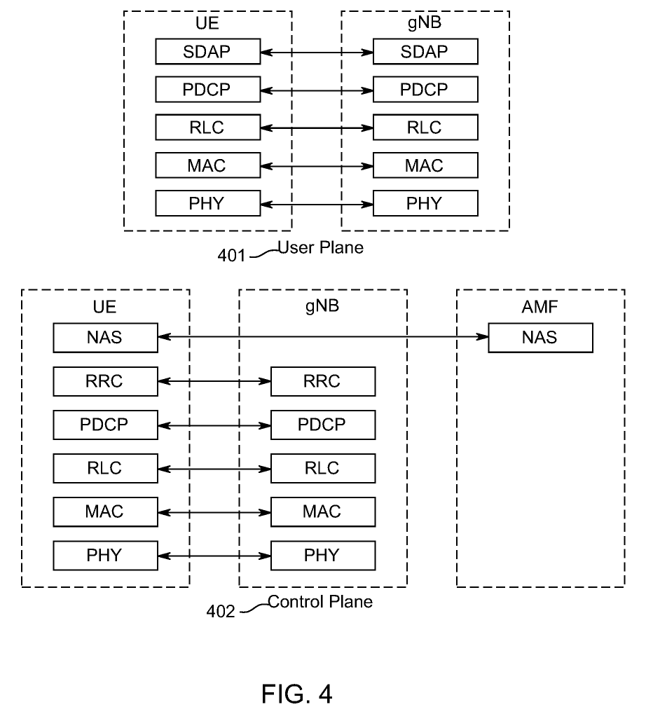

FIG. 4 illustrates an example of a protocol stack for the user plane and control plane. The user plane protocol stack 401 and the control plane stack 402. A higher layer may refer to one or more layers in a protocol stack, or a specific sublayer within the protocol stack. The protocol stack may comprise one or more layers in a UE or a network node (e.g., eNB, gNB, other functional entity, etc.), where each layer may have one or more sublayers. Each layer/sublayer may be responsible for one or more functions. Each layer/sublayer may communicate with one or more of the other layers/sublayers, directly or indirectly. In some cases, these layers may be numbered, such as Layer 1, Layer 2, and Layer 3. For example, Layer 3 may comprise of one or more of the following: NAS, Internet Protocol (IP), and/or Radio Resource Control (RRC). For example, Layer 2 may comprise of one or more of the following: Packet Data Convergence Control (PDCP), Radio Link Control (RLC), and/or Medium Access Control (MAC). For example, Layer 1 may comprise of physical (PHY) layer type operations. The greater the number of the layer, the higher it is relative to other layers (e.g., Layer 3 is higher than Layer 1). In some cases, the aforementioned examples may be called layers/sublayers themselves irrespective of layer number, and may be referred to as a higher layer as described herein. For example, from highest to lowest, a higher layer may refer to one or more of the following layers/sublayers: a NAS layer, a RRC layer, a PDCP layer, a RLC layer, a MAC layer, and/or a PHY layer. Any reference herein to a higher layer in conjunction with a process, device, or system will refer to a layer that is higher than the layer of the process, device, or system. In some cases, reference to a higher layer herein may refer to a function or operation performed by one or more layers described herein. In some cases, reference to a high layer herein may refer to information that is sent or received by one or more layers described herein. In some cases, reference to a higher layer herein may refer to a configuration that is sent and/or received by one or more layers described herein. In one example, a base station may be distributed (e.g., different units that address or include different functions/layers/protocols/hardware/etc.; a first unit, second unit, etc.). In some examples (e.g., in an NR implementation), Layer 2 may further include a service data adaptation protocol (SDAP) sublayer (not shown) that may support mapping between QoS flows and one or more data radio bearers. One of ordinary skill will appreciate that analogous or corresponding sublayers may exist in other access technologies.

A residential gateway (RG) is a device providing, for example, voice, data, broadcast video, video on demand, etc. to other devices in specific locations referred to as customer premises. In this example, an RG may have one or more processors, such as Central Processing Units (CPUs), Graphical Process Units (GPUs), Front End Processors (FEPs), Communication Processors (CPs), Field Programmable Gate Arrays (FPGAs), Vision Processing Units (VPU), Quantum Processing Units (QPUs), Associative Processing Units (APUs), and Tensor Processing Units (TPUs); a baseband radio; one or more transceivers; one or more antennas; storage, such as HDD, SSD, NVM, RAM, ROM, memory, cache; memory controller(s), a touchscreen, and a power source. The RG may also have one or more of its functions virtualized. In one or more examples provided herein, an RG may be used in place of a UE without loss of capability or functionality.

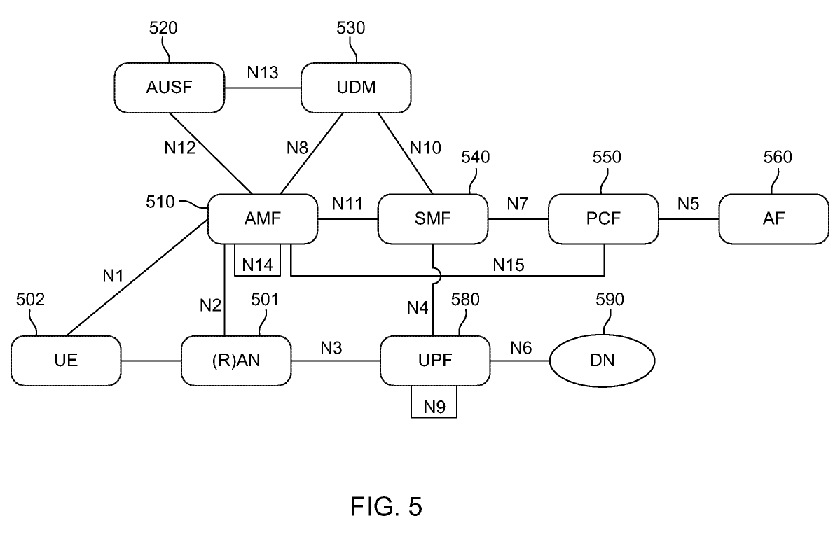

FIG. 5 illustrates an example of 5G architecture, including a 5GC. As shown in an example in FIG. 5, the NFs, for example, AMF 510, SMF 540, unified data management (UDM) function 530, communicate with each other using SBI, using protocols such as HTTP. The goal of the Service Based Architecture (SBA) is to enable NFs to expose services, for example, using APIs following the principles of RESTful APIs, to other NFs, for the system to provide the desired functionality. For example, the authentication server function (AUSF) 520 may communicate with other NFs using SBI. However, the current 5G System Architecture does not consistently offer a full Service Based environment. While most interaction may be supported using SBI, there are some 5G interfaces that currently remain exclusively as point-to-point interfaces between two entities. Embodiments and examples provided herein provide improved use of SBI.

In an example in FIG. 5, there may be a UE 502 connecting to a (R)AN node 501 via an air interface. In an example, the UE 502 may be an RG, such as a 3GPP capable 5G-RG. An N1 interface may be established between the UE 502 and the AMF 510, and an N2 interface may be established between the (R)AN node 501 and the AMF 510. The AMF 510 may connect with the AUSF 520 via an N12 interface, the UDM 530 via an N8 interface, the SMF 540 via an N11 interface, and a policy control function (PCF) 550 via an N15 interface. Further, the AMF 510 may access another AMF via an N14 interface.

Further, the AUSF 520 may access the UDM 530 via an N13 interface, and the SMF 540 via an N10 interface. In turn, the SMF 540 may access the UPF 580 via an N4 interface, and the PCF 550 via an N7 interface. The PCF 550 may access an application function (AF) 560 via an N5 interface. Moreover, the UPF 580 may access the (R)AN node 501 via an N3 interface, a DN 590 via an N6 interface, and another UPF via an N9 interface.

For completeness, other nodes may be used in 5G architecture which are not shown in the examples in FIG. 5, but which may work with the nodes shown. One or more of these NFs may also be used in 6G architecture.

Examples of key requirements for a network-agnostic AMF with embedded Interworking Function (IWF) capabilities are provided in the following. The capabilities may include unified mobility and session management across access networks. For example, the AMF manages registration, mobility, and session continuity not only for 3GPP access (5G NR, LTE) but also for non-3GPP access (Wi-Fi, fixed networks, satellite, etc.). This involves directly handling traffic handover between these different networks without the need for a separate IWF node.

In an example, the AMF may leverage a common mobility framework that abstracts the specifics of each access type, whether the user is on a 5G NR, LTE, or non-3GPP access.

Further embedded IWF capabilities may include embedded traffic steering and switching. For example, a network-agnostic AMF may embed the capabilities of the Access Traffic Steering, Switching, and Splitting (ATSSS) framework within the AMF, which allows the AMF to dynamically steer traffic across multiple access technologies (for example, both 3GPP and non-3GPP access technologies).

This allows for optimal traffic management without involving a separate IWF. ATSSS decisions on traffic routing and session continuity, handled by an ATSSS proxy, an ATSSS client, or both, ensure that users have seamless experiences across networks without interruptions. The ATSSS decisions may be based on ATSSS policies stored in a PCF. The ATSSS proxy may be, or may be located in, a UPF. Additionally or alternatively, the ATSSS client may be, or may be located in, a device, such as a handset, UE or RG.

Also, embedded IWF capabilities may include consolidated control functions. For example, the network-agnostic AMF should manage both access and mobility control for different network domains in a consolidated manner. By integrating IWF functions directly into the AMF, the AMF can handle one or any combination of: authentication of non-3GPP users; IP session management for Wi-Fi and fixed broadband users (for example, using a non-3GPP interworking function (N3IWF) or trusted non-3GPP gateway function (TNGF)-like capabilities); or handover between 5G NR and non-3GPP networks like Wi-Fi, ensuring seamless service continuity.

In addition, embedded IWF capabilities may include harmonized QoS management. For example, the AMF needs to support consistent QoS management across all access networks. With embedded IWF functionality, the AMF can enforce QoS policies uniformly for both 3GPP and non-3GPP access networks, ensuring users get the same level of service regardless of which access technology is in use.

Additionally or alternatively, embedded IWF capabilities may include policy control and enforcement. The AMF, integrated with the PCF and SMF, should ensure that policy enforcement (such as steering traffic, QoS, and security policies) is managed uniformly across access networks. This also removes the need for a standalone IWF, as policy decisions regarding access technologies are handled within the core.

Additionally or alternatively, embedded IWF capabilities may include seamless Interworking without Tunneling Overhead. Traditionally, the IWF function relies on tunneling mechanisms like IPSec to bridge 3GPP and non-3GPP networks. By integrating this functionality into the AMF, the network can reduce the need for tunneling protocols, allowing direct, secure handoffs between access networks. This reduces overhead and increases network efficiency.

Additionally or alternatively, embedded IWF capabilities may include Flexibility for Future Access Networks. Specifically, a network-agnostic AMF with embedded IWF capabilities should be designed to accommodate future non-3GPP technologies beyond Wi-Fi, such as low-earth orbit satellites, edge-based networks, or new radio technologies. This futureproofing eliminates the need to update separate IWF functions for each new network type.

The following are examples of key benefits of having the AMF support IWF functionality. One key benefit is simplified network architecture. Integrating IWF capabilities within the AMF reduces the need for separate, dedicated interworking nodes, leading to a simplified and more streamlined network architecture. This minimizes signaling overhead and network complexity while reducing capital expenditures (CAPEX) and operating expenses (OPEX) for operators.

Another key benefit of having the AMF support IWF functionality is enhanced mobility management. The AMF handles mobility management in 5G networks, ensuring users can seamlessly move between different access technologies (e.g., 4G to 5G, or 5G to non-3GPP networks like Wi-Fi). By supporting IWF, the AMF can facilitate even smoother handover and session continuity between heterogeneous networks, ensuring minimal disruption in services.

A further key benefit of having the AMF support IWF functionality is seamless Integration of Non-3GPP Networks. With IWF functionality integrated into the AMF, the interworking between 5G and non-3GPP networks (like Wi-Fi or fixed networks) can be more efficient. This enables better support for scenarios like ATSSS (Access Traffic Steering, Switching, and Splitting), where traffic flows seamlessly between different access technologies based on network conditions.

Additionally or alternatively, a key benefit of having the AMF support IWF functionality is improved QoS. The AMF, when coupled with IWF, can ensure that the Quality of Service (QoS) parameters are maintained across different network technologies. This is particularly important in use cases like voice over Wi-Fi, mission-critical services, or IoT applications where QoS continuity across networks is crucial.

Additionally or alternatively, a key benefit of having the AMF support IWF functionality is better scalability and flexibility. Combining IWF functionality into the AMF allows for better scalability, as the need for separate interworking solutions diminishes. Operators can flexibly manage and extend their networks across multiple generations (4G, 5G) and access technologies without adding much complexity to the core.

Additionally or alternatively, a key benefit of having the AMF support IWF functionality is support for convergence in 6G. As networks move toward 6G, with a focus on converged access technologies, having AMF with integrated IWF will enable easier transitions between different access types and prepare networks for ubiquitous connectivity across all domains.

Integrating IWF functionality into the AMF can lead to a more unified network management process, offering benefits in terms of efficiency, seamlessness, QoS management, and operational cost savings. This integration helps pave the way for the convergence goals that are essential for advanced connectivity in 5G and beyond.

The following are examples of key benefits of making the AMF network-agnostic. One key benefit is a unified user experience. Users can move seamlessly between access technologies (like 5G and Wi-Fi) without noticing any disruption in their connectivity or services.

Another key benefit of making the AMF network-agnostic is a simplified core. As a result, operators can manage different types of access networks more efficiently, reducing the need for multiple core network functions tailored to specific access technologies.

A further key benefit of making the AMF network-agnostic is optimized traffic Routing. With a network-agnostic AMF, traffic can be intelligently routed based on real-time network conditions, optimizing performance and resource utilization.

An additional key benefit of making the AMF network-agnostic is future-proof Architecture. Being agnostic to access technologies ensures that the AMF can support future evolutions in wireless networks, such as 6G or other non-3GPP networks, without significant architectural changes.

This network-agnostic approach aligns well with the convergence goals of 6G, enabling ubiquitous connectivity across a diverse range of access technologies and providing a seamless user experience regardless of the network used.

The following include key architectural changes, interface modifications, and protocol adaptations related to a modified AMF. An enhanced AMF architecture herein is used for network agnosticism. The AMF herein is upgraded to support both 3GPP (e.g., 5G NR, LTE) and non-3GPP access (e.g., Wi-Fi, Fixed Broadband).

This upgrade implies several architectural updates, including extended mobility and session management. The AMF herein handles mobility and session continuity across both 3GPP and non-3GPP networks. For non-3GPP networks, like Wi-Fi, the AMF herein manages registration, authentication, session establishment, and handovers similarly to how it handles 3GPP networks.

The related changes needed include one or more of the following. Non-3GPP access type registration is used, in an example, including a mechanism for registering non-3GPP access types, such as Wi-Fi, via an extended UE registration procedure within the AMF.

Additionally or alternatively, an access discovery mechanisms is used, in an example. The AMF herein adopts mechanisms for discovery and selection of non-3GPP access points (APs). For instance, the AMF selects the most optimal Wi-Fi AP based on policy, QoS, and mobility patterns.

Additionally or alternatively, seamless handover support is used by the AMF herein, in an example. The AMF herein uses integration of protocols that support handover between 3GPP and non-3GPP networks without session interruption, like make-before-break handovers.

Another architectural update includes embedded ATSSS, in an example. Embedding ATSSS logic within the AMF allows it to handle traffic steering between different access types. The AMF herein supports policies from the PCF for traffic management between 5G NR and non-3GPP access (e.g., Wi-Fi or fixed networks).

Further, several interfaces between the core network elements will be impacted and require adaptation to support this new architecture provided herein. For example, the N2 Interface (between the AMF and gNB (for 3GPP access) and between the AMF and other access nodes (for non-3GPP access) herein is modified to accommodate non-3GPP networks, allowing the AMF to manage both RAN-level (3GPP) and non-3GPP access points (e.g., Wi-Fi APs).

Further, as part of AMF to N3IWF integration, the N2 interface will support interaction with the N3IWF (Non-3GPP Interworking Function) functionalities directly within the AMF for non-3GPP access, in an example herein.

New signaling extensions to N2 is used to handle events specific to non-3GPP access, such as Wi-Fi connection management, IP address allocation, and session management, in an example herein.

Also, the N3 Interface, connecting the User Plane Function (UPF) to the RAN is herein generalized to support non-3GPP access directly, bypassing the need for an N3IWF (traditionally required to handle non-3GPP IPsec tunnels).

The AMF, in an example herein, seamlessly allocates traffic resources across 3GPP and non-3GPP domains without relying on intermediary nodes.

The N4 interface between the Session Management Function (SMF) and UPF supports non-3GPP flows in an example herein. This requires adaptation to policy and QoS decisions that cover both access types, and the ability to enforce the same traffic rules for data flows traversing 5G NR, Wi-Fi, or fixed networks.

Example solutions provided herein include protocol modifications. Control plane protocol enhancements are provided herein. Herein, the AMF uses updated control plane protocols, particularly the GTP-C (GPRS Tunneling Protocol Control Plane) used for signaling between AMF and other nodes like SMF and gNB.

The protocol herein is extended to handle non-3GPP-specific procedures, including Authentication, Authorization, and Accounting (AAA) integration for non-3GPP access, as non-3GPP access networks typically use EAP-based authentication.

The protocol herein also uses QoS Control Extensions. The QoS control framework currently built for 5G NR and LTE is herein extended to handle Wi-Fi QoS metrics (e.g., Wi-Fi Multimedia (WMM) support).

Session Management and Handover Protocols are modified herein. The AMF integrates session management protocols that are flexible across both access types. This involves translating Wi-Fi session initiation and authentication messages into 3GPP-compatible protocols (e.g., NAS signaling).

Protocols like PMIP (Proxy Mobile IP) and GTP are adapted to ensure seamless handovers and to handle non-3GPP access without requiring tunneling through a separate IWF, in an example herein.

Example solutions provided herein include unified QoS and traffic steering. To maintain a consistent QoS across both 3GPP and non-3GPP access, the following updates are applied herein.

QoS Mapping is applied herein. The AMF herein supports QoS mapping between different types of access. For example, the AMF herein translates Wi-Fi QoS (WMM) to 5G's 5QI (5G QoS Indicator) framework, ensuring that applications like voice, video, or low-latency IoT traffic receive consistent priority across access types. Additionally or alternatively, the AMF herein performs the QoS mapping, and related translations, based on policies provided by the PCF.

Policy Enforcement is applied herein. The AMF should work with the PCF (Policy Control Function) and SMF to enforce ATSSS policies for traffic splitting, steering, and switching based on real-time conditions such as network load, signal strength, or user profile preferences.

Example solutions provided herein include modified security and authentication protocols. Security and authentication are critical, especially when supporting non-3GPP access.

An example solution herein includes embedded IPSec handling. The AMF herein directly handles the IPSec-based tunneling (currently managed by N3IWF) for encrypting traffic between non-3GPP devices and the core network.

This involves adapting the AMF to initiate, manage, and terminate IPSec tunnels with minimal delay. Additionally, the AMF herein supports Internet Key Exchange version 2 (IKEv2) procedures for key exchange during IPSec setup with non-3GPP access points.

An example solution herein includes authentication. The AMF herein handles both 5G-AKA (Authentication and Key Agreement) for 3GPP access and EAP-based authentication for Wi-Fi and other non-3GPP networks. This means incorporating authentication protocols typically managed by AAA servers in Wi-Fi networks, as well as maintaining compatibility with 3GPP security protocols.

Example solutions provided herein include modified handover mechanisms. The AMF herein supports make-before-break handovers between 3GPP and non-3GPP networks.

These handovers involve session context retention. For example, when switching from one access network to another (e.g., 5G NR to Wi-Fi), the AMF herein stores and transfers the session context (e.g., IP address, QoS, and security keys) to the new access point without interrupting ongoing sessions.

Further examples include non-3GPP to 3GPP handovers. The handover procedure herein ensures that traffic is seamlessly rerouted from non-3GPP access (e.g., Wi-Fi) to 3GPP (e.g., 5G NR) and vice versa. This requires an efficient session state synchronization protocol.

Making the AMF access network agnostic while supporting IWF functionality requires significant updates to the core architecture, interfaces (N2, N3, N4), and protocols (GTP, PMIP, IPSec). The AMF herein handles mobility management, session continuity, QoS enforcement, security, and traffic steering for both 3GPP and non-3GPP access. By embedding the functionality of the IWF within the AMF, network complexity is reduced, overhead is minimized, and true convergence between access types is achieved.

Examples of enhancements to the AMF are provided in the following. A universal protocol stack within the AMF may interpret and handle signaling requests from multiple RATs without the need for interworking functions (IWFs). This enhancement involves creating a flexible signaling layer capable of adapting to various access protocols (e.g., LTE, NR, Wi-Fi).

Another enhancement includes the ability to convert RAT-specific details into a common format, allowing the AMF to manage and process requests uniformly. The AMF dynamically handles different authentication protocols based on the detected access type, such as EAP (Extensible Authentication Protocol) for Wi-Fi, SIM-based authentication for 3GPP networks, and certificate-based authentication for secure enterprise networks.

A further enhancement includes the consistent mapping of data flows and QoS profiles to help maintain a seamless experience regardless of the access network. Additionally or alternatively, enhanced SMF and PCF coordination manages and enforces QoS levels across all sessions.

Additionally or alternatively, an enhancement includes the ability to interface with session management layer capable of real-time packet inspection and steering based on application and network needs, redirecting traffic over multiple paths.

Additionally or alternatively, an enhancement includes the support of an N1 interface with an abstracted signaling layer to accommodate diverse access technologies. By making the N1 signaling flexible, the AMF can send control messages that accommodate specific capabilities of each RAT without losing uniformity. The N1 message headers are expanded to include tags or markers indicating access type, in an example.

Additionally or alternatively, an enhancement includes the support of an N2 interface which is able to interface with both 3GPP and non-3GPP RAN nodes, including implementing a Unified RAN Abstraction Layer. This layer could act as an intermediary between AMF and various RAN nodes, translating generic N2 service messages into RAT-specific formats. Additionally or alternatively, open-source protocols like NG-RAN F1 may include modifications to support this abstraction layer, in an example.

Additionally or alternatively, an enhancement includes the NRF modified to support the discovery of access-agnostic AMF instances, which can register as dynamically adaptive based on access type. This enables the network to balance loads across RAT-agnostic AMF instances based on service demand and access type availability.

Additionally or alternatively, an enhancement includes expanded NRF service registration protocols to include specific tags or metadata fields that identify AMF instances by supported RATs and specific access network capabilities (e.g., EAP support, specific QoS profiles).

Additionally or alternatively, an enhancement includes enhanced coordination between the UDM, PCF (Policy Control Function), and SMF (Session Management Function) and thereby enables more efficient handling of user identities, session continuity, and QoS across different RATs without additional translation functions.

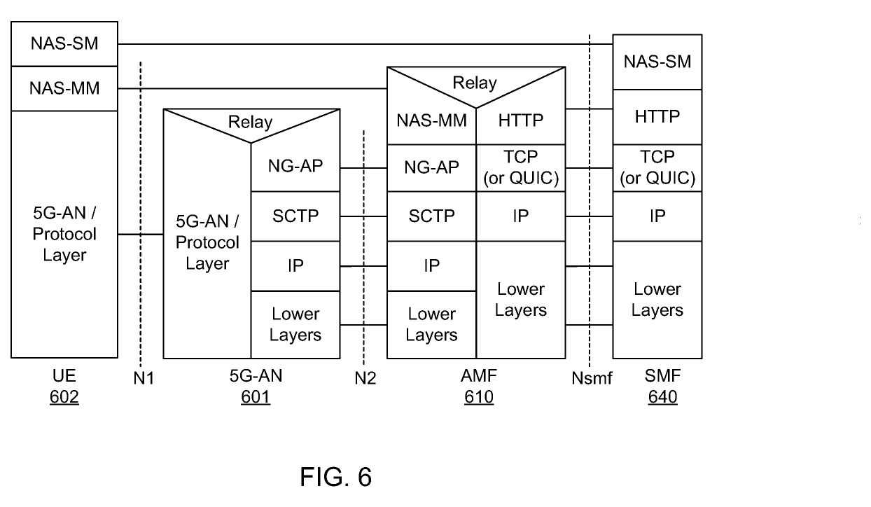

FIG. 6 illustrates an example of interfaces for the control plane for 5G-New Radio (5G-NR) access in 5G. As shown in an example in FIG. 6, a UE 602 may access a 5G network. For example, the control plane protocol stack for 5G-NR access by UE 602 may include an NAS-session management (SM) layer, an NAS-mobility management (MM) layer, and a 5G-access network (AN) protocol layer. The UE 602 may access the a 5G-AN node 601 via a Uu interface (not shown) for 5G-AN protocol layer communications. In an example in FIG. 6, the CN may be a 5G CN. Accordingly, the UE 602 may access an AMF 610 via an N1 interface, by way of the 5G-AN node 601, for the NAS-MM layer communications, and the UE 602 may access an SMF 640 via an Nsmf interface for NAS-MM layer communications. Physical access between the UE 602 and the AMF 610 and SMF 640 may be via the 5G-AN node 601.

Further, the 5G-AN node 601 may access the AMF 610 via an N2 interface for next generation (NG)-application protocol (AP), stream control transmission protocol (SCTP), IP, and lower layer communications. Moreover, the AMF 610 may access the SMF 640 via the Nsmf interface for HTTP, TCP (or QUIC), IP and lower layer communications.

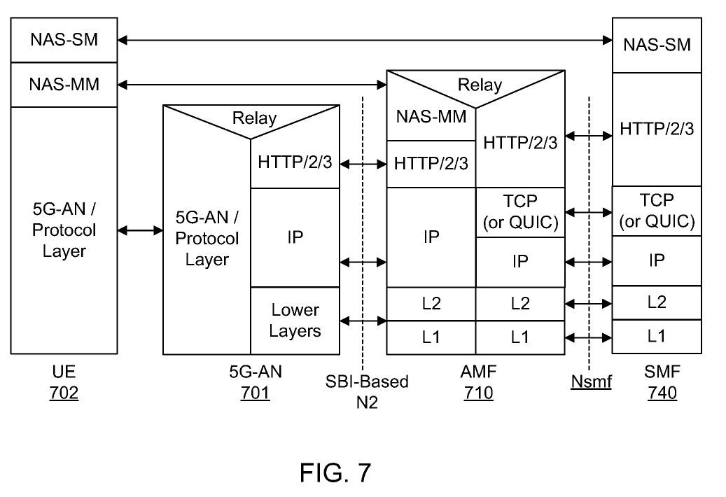

FIG. 7 illustrates an example of interfaces for the proposed control plane for 5G-NR access in 6G and beyond. As shown in an example in FIG. 7, a UE 702 may access a 6G CN via a 5G-AN 701. For example, the control plane protocol stack for 5G-NR access by UE 702 may include an NAS-SM layer, an NAS-MM layer, and a 5G-AN protocol layer. The UE 702 may access the 5G-AN node 701 via a Uu interface for 5G-AN protocol layer communications. Further, the UE 702 may access an AMF 710 via an N1 interface, by way of the 5G-AN node 701, for the NAS-MM layer communications, and the UE 702 may access an SMF 740 for NAS-SM layer communications. Physical access between the UE 702 and the AMF 710 and SMF 740 may be via the 5G-AN node 701.

Further, the 5G-AN node 701 may access the AMF 710 via an SBI-based N2 interface for HTTP, IP and lower layer (such as L1 and L2 in AMF 710) communications. In an example, the HTTP protocol is an HTTP/2 protocol. In another example, the HTTP protocol is an HTTP/3 protocol. Moreover, the AMF 710 may access the SMF 740 via an Nsmf interface for HTTP/2 (or HTTP/3), TCP (or QUIC), IP, L2 and L1 layer communications.

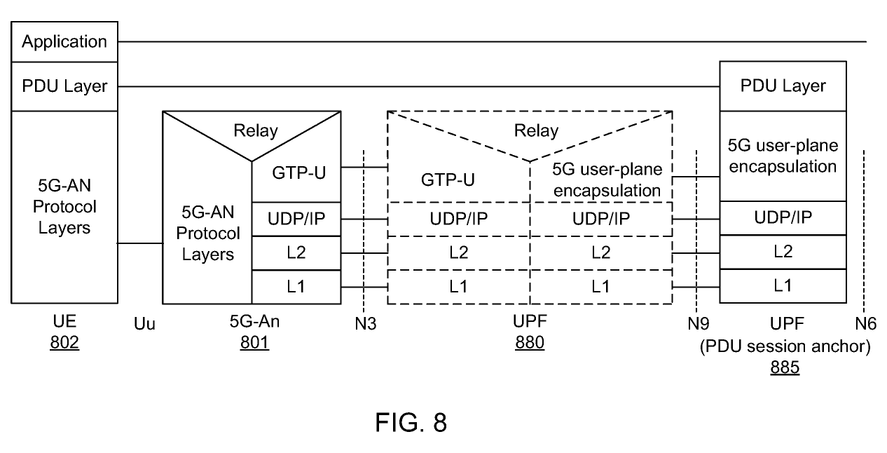

FIG. 8 illustrates an example of illustrates an example of interfaces for the user plane for 5G-NR Access in 5G. As shown in an example in FIG. 8, a UE 802 may access a 5G CN via a 5G-AN 801. For example, the user plane protocol stack for 5G-NR access by UE 802 may include an application layer, a PDU layer, and a 5G-AN protocol layer. The UE 802 may access the 5G-AN node 801 via a Uu interface (as also noted above in description regarding FIG. 3) for 5G-AN protocol layer communication. Further, the UE 802 may access, via an N3 interface, a UPF 885, acting as a PDU session anchor for PDU layer communication.

Further, the 5G-AN node 801 may access a UPF 880 via an N3 interface for General Packet Radio Service (GPRS) Tunneling Protocol for User Plane (GTP-U) protocol, UDP/IP, L2 and L1 layer communications. Moreover, the UPF 810 may access the UPF 885 via an N9 interface for 5G user-plane encapsulation, UDP/IP, L2 and L1 layer communications. In a further example, the UPF 885 may access a DN (not shown) via an N6 interface.

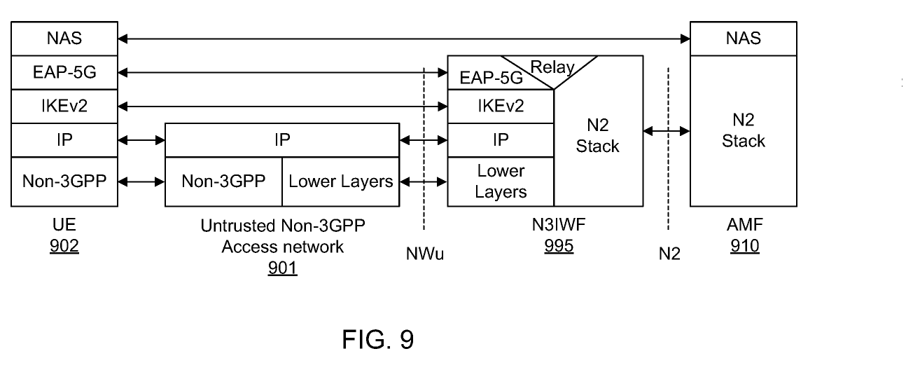

FIG. 9 illustrates an example of interfaces for the control plane for non-3GPP access in 5G. As shown in an example in FIG. 9, a UE 902 may access a 5G CN via an untrusted non-3GPP access network node 901, such as an untrusted WLAN. For example, the control plane protocol stack for untrusted non-3GPP access by UE 902 may include an NAS layer, an EAP-5G layer, an IKEv2 layer, an IP layer and a non-3GPP access layer. In examples, the UE 902 may be a mobile station, an RG, a 5G-RG, a STA, or a CPE. The UE 902 may access the untrusted non-3GPP access network node 901 via a variety of interfaces, including wireline, Wi-Fi, Uu and the like for IP layer and non-3GPP layer communications. Further, the UE 902 may access an N3IWF 995 via an NWu interface (for untrusted non-3GPP access) for EAP-5G layer communication and IKEv2 layer communication. In a further example (not shown), of trusted access, the UE may use a NWt interface. Moreover, the UE 902 may access an AMF 910, via an N1 interface, for NAS layer communication.

Further, the untrusted non-3GPP access network node 901 may access the N3IWF 995 via the NWu interface for communications of the IP layer and lower layers. Moreover, the N3IWF 995 may access the AMF 910 via an N2 interface for N2 protocol layer stack communication.

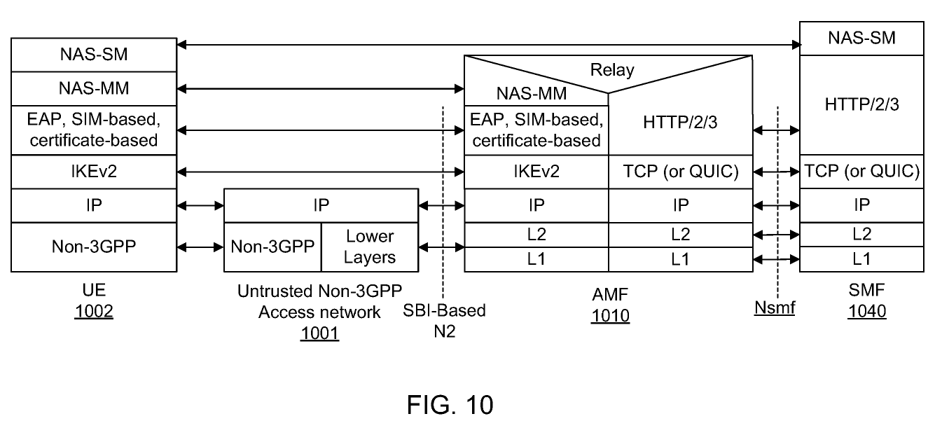

FIG. 10 illustrates an example of interfaces for the proposed control plane for non-3GPP access in 6G and beyond. As shown in an example in FIG. 10, a UE 1002 may access a 6G CN via an untrusted non-3GPP access network node 1001. As in FIG. 9, the UE 1002 may be a mobile station, an RG, a 5G-RG, a STA, or a CPE. In an example, the proposed control plane for non-3GPP Access in 6G by UE 1002 may include an NAS-SM layer, an NAS-MM layer, a layer for EAP, SIM-based and certificate based communication, an IKEv2 layer, an IP layer and a non-3GPP access layer. The UE 1002 may access the untrusted non-3GPP access network node 1001 via a variety of interfaces, as in FIG. 9, for IP layer and non-3GPP layer communication. Also, the UE 1002 may access an AMF 1010 via an SBI-based N1 interface for NAS-MM, EAP, SIM-based, certificate based, and IKEv2 layer communications. Moreover, the UE 1002 may access an SMF 1040 for NAS-SM layer communication.

Further, the untrusted non-3GPP access network node 1001 may access the AMF 1010 via an SBI-based N2 interface for communications for the IP layer and lower (L2 and L1) layers. Moreover, the AMF 1010 may access the SMF 1040 via an Nsmf interface for HTTP/2 (or HTTP/3), TCP (or QUIC), IP, L2 and L1 layer communications.

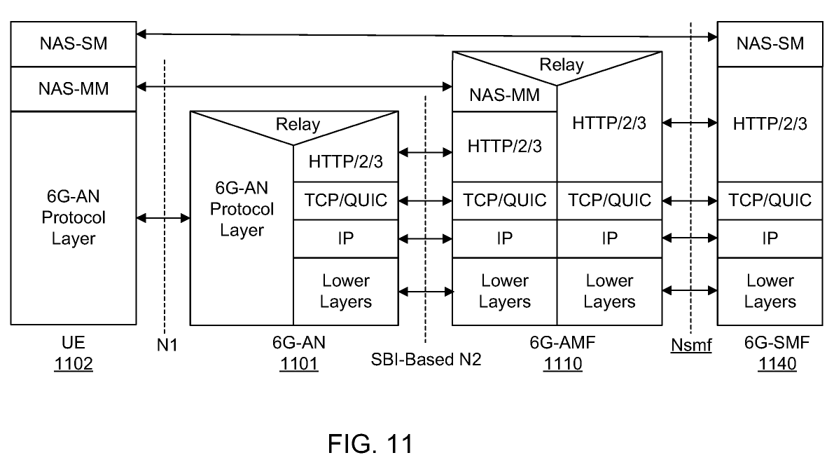

FIG. 11 illustrates an example of interfaces for the proposed control plane for 6G access and non-3GPP access in 6G and beyond. As shown in an example in FIG. 11, a UE 1102 may access a 6G CN via a 6G-AN 1101. As in FIGS. 9 and 10, the UE 1102 may be a mobile station, an RG, a 5G-RG, a 6G-RG, a STA, or a CPE. In an example, the proposed control plane for UE 1102 may include an NAS-SM layer, an NAS-MM layer, and a 6G-AN protocol layer. The UE 1102 may access the 6G-AN 1101 via an N1 interface for 6G-AN protocol layer communication, in an example of 6G access. In an example where the UE 1102 is an RG, a 5G-RG, or a 6G-RG, the UE uses wireline access to connect with the 6G-AN 1101 for 6G-AN protocol layer communication. Further, the UE 1102 may access a 6G-AMF 1110 via the N1 interface for NAS-MM layer communication. Moreover, the UE 1102 may access a 6G-SMF 1140 for NAS-SM layer communication.

Further, the 6G-AN node 1101 may access the 6G-AMF 1110 via an SBI-based N2 interface for HTTP, TCP/QUIC, IP and lower layer communications. In an example, the HTTP protocol is an HTTP/2 protocol. In another example, the HTTP protocol is an HTTP/3 protocol. Moreover, the AMF 1110 may access the 6G-SMF 1140 via the Nsmf interface for HTTP/2 (or HTTP/3), TCP/QUIC, IP, and lower layer communications.

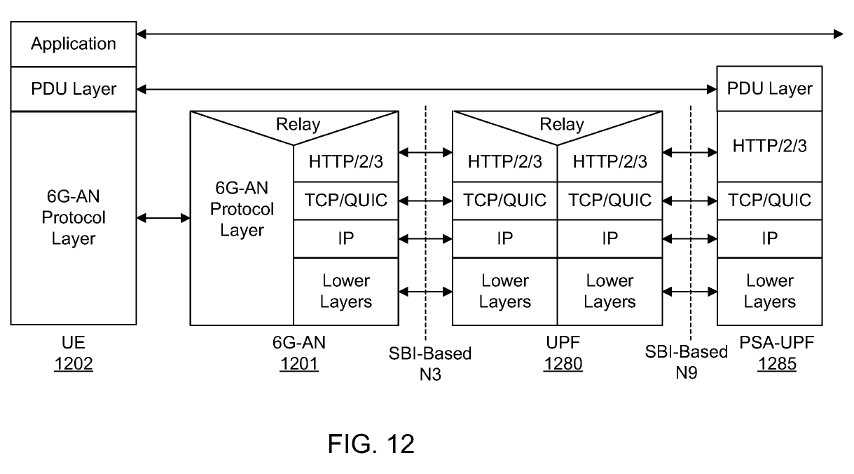

FIG. 12 illustrates an example of interfaces for the proposed user plane for 6G access and non-3GPP access in 6G and beyond. As shown in an example in FIG. 12, a UE 1202 may access a 6G CN via a 6G-AN 1201. As in FIGS. 9-11, the UE 1201 may be a mobile station, an RG, a 5G-RG, a 6G-RG, a STA, or a CPE. In an example, the proposed user plane for the UE 1202 may include an application layer, PDU layer and 6G-AN protocol layer. The UE 1202 may communicate with the 6G-AN 1201 using the 6G-AN protocol layer. Further, the UE 1202 may communicate with a PDU session anchor (PSA)-UPF 1285 using the PDU layer. Moreover, the UE 1202 may communicate with a node hosting an application server (not shown) over an application layer.

Further, the 6G-AN node 1201 may access a UPF 1280 via an SBI-based N3 interface for HTTP, TCP/QUIC, IP and lower layer communications. In an example, the HTTP protocol is an HTTP/2 protocol. In another example, the HTTP protocol is an HTTP/3 protocol. Moreover, the UPF 1280 may access the PSA-UPF 1285 via the SBI-Based N9 interface for HTTP/2 (or HTTP/3), TCP/QUIC, IP, and lower layer communications.

In an example, a network function dynamically supports various RATs, including 3GPP and non-3GPP access networks, without requiring interworking functions. This network function automatically adapts to new access types with minimal configuration adjustments. Additionally or alternatively, an AMF directly interfaces with non-3GPP access networks (e.g., Wi-Fi) over standard SBIs, utilizing N1 and N2 interfaces without interworking function requirements. Additionally or alternatively, a unified protocol adaptation and signaling translator in AMF automatically translates signaling from multiple RAT-specific formats (e.g., LTE NAS, NR NAS, or Wi-Fi signaling) into a standard protocol for consistent session management.

Additionally or alternatively, a system within the AMF dynamically adjusts QoS settings and maintains uniform service levels across different RATs, enabling seamless transition and QoS continuity across sessions using multiple access networks. Additionally or alternatively, the AMF is deployed at the network edge to reduce latency and handle service requests from multiple access technologies, with capabilities for service continuity and low-latency applications in IoT and URLLC. Additionally or alternatively, a central repository integrated within the AMF maintains subscriber information, policies, and session details uniformly across access networks, supporting cross-RAT data consistency and session continuity. Additionally or alternatively, a system supports network slicing across both 3GPP and non-3GPP RATs, enabling the creation and management of slices that span heterogeneous access networks, enhancing service continuity for applications spanning multiple RATs.

Additionally or alternatively, a mechanism within the AMF manages different authentication methods (e.g., EAP, SIM-based, certificate-based) dynamically based on the RAT being used, without requiring specific authentication intermediaries or interworking functions. Additionally or alternatively, a system supports seamless, stateless, and HTTP/2-based communication (or HTTP/3) to align with other SBI protocols. This enables better support for microservices, stateless communication, and flexible resource management. As a result, the system replaces SCTP used for N2 interactions.

Additionally or alternatively, the system introduces a RESTful API structure for N2 interactions to support scalable and modular communication among control plane functions. Additionally or alternatively, an example method restructures current procedures (e.g., registration, handover, and bearer management) into discrete services. Each service has defined APIs to enable modular interactions and allow flexibility in integrating NFs.

Additionally or alternatively, a control plane uses consistent data models and schemas for status updates, UE context information, and handover data across N2, aligning with service-based principles for efficient integration with other NFs.

Additionally or alternatively, a method includes redefining policy control elements on the N2 interface to fit into an API-driven model. Policies, accordingly, need to be managed and enforced through a common framework compatible with other SBIs.

Additionally or alternatively, a plurality of context-sharing protocols allow NFs (like the AMF and SMF) to seamlessly share session details, user information, and mobility status with N2-enabled services.

In an example, an AN node receives, from a UE, a first message. The AN node forwards, to a CN node, the first message directly via an SBI interface using an HTTP protocol. Further, the AN node receives, from the CN node, a second message directly via the SBI interface using the HTTP protocol. The AN node transmits the second message to the UE.

In examples, the UE is one or more of an RG, a 5G RG, a STA, or a CPE. Additionally or alternatively, the CN node is a UPF node, and the SBI interface is an N3 interface.

Additionally or alternatively, the CN node is an AMF node, and the SBI interface is an N2 interface. Additionally or alternatively, the AN node and the CN node communicate using one of: 3GPP access, trusted non-3GPP access, or untrusted non-3GPP access. Additionally or alternatively, the HTTP protocol is one of: an HTTP/2 protocol or an HTTP/3 protocol.

In another example, an AMF node receives, from a first AN node via an SBI-based N2 interface, a first message in a first RAT-specific format. The AMF node translates the first message from the first RAT-specific format into a unified protocol. Further, the AMF node sends, directly to a CN node, the translated first message via an SBI interface using an HTTP protocol. Also, the AMF node receives, directly from the CN node via the SBI interface using the HTTP protocol, a second message in the unified protocol. The AMF node translates the second message from the unified protocol into the first RAT-specific format. Moreover, the AMF node sends, to the first AN node via the SBI-based N3 interface, the translated second message.

Additionally or alternatively, the CN node is an SMF node, and the SBI interface using the HTTP protocol is an Nsmf interface. Additionally or alternatively, the first AN node is one of: a 5G-AN node or a 6G-AN node.

Additionally or alternatively, the AMF node and the first AN node communicate using one of: 3GPP access, trusted non-3GPP access, or untrusted non-3GPP access. Additionally or alternatively, the HTTP protocol is one of: an HTTP/2 protocol or an HTTP/3 protocol.

Additionally or alternatively, the first message and the second message are control plane messages.

Additionally or alternatively, the AMF node receives, from a second AN node via an SBI-based N2 interface, a third message in a second RAT-specific format. The AMF node translates the third message from the second RAT-specific format into a unified protocol. Further, the AMF node sends, directly to a CN node, the translated third message via an SBI interface using a HTTP protocol. Also, the AMF node receives, directly from the CN node via the SBI interface using the HTTP protocol, a fourth message in the unified protocol. The AMF node translates the fourth message from the unified protocol into the second RAT-specific format. Moreover, the AMF node sends, to the second AN node via the SBI-based N2 interface, the translated fourth message.

Additionally or alternatively, the first AN node is a 3GPP AN node, and the second AN node is an untrusted non-3GPP AN node. Alternatively, the first AN node is an untrusted non-3GPP AN node, and the second AN node is a 3GPP AN node.

In a further example, a UPF node receives from an AN node via an SBI-based N3 interface, a first message in a RAT-specific format. The UPF node translates the first message from the RAT-specific into a unified protocol. Further, the UPF node sends, directly to a CN node, the translated first message via an SBI interface using an HTTP protocol. Also, the UPF node receives, directly from the CN node via the SBI interface using the HTTP protocol, a second message in the unified protocol. The UPF node translates the second message from the unified protocol into the RAT-specific format. Moreover, the UPF node sends, to the first AN node via the SBI-based N3 interface, the translated second message.

Additionally or alternatively, the CN node is a PSA-UPF, the SBI interface using the HTTP protocol is an SBI-based N9 interface, and the first message and the second message are user plane messages. Additionally or alternatively, the first AN node is one of: a 5G-AN node or a 6G-AN node. Additionally or alternatively, the UPF node and the first AN node communicate using one of: 3GPP access, trusted non-3GPP access, or untrusted non-3GPP access. Additionally or alternatively, the HTTP protocol is one of: an HTTP/2 protocol or an HTTP/3 protocol.

Although features and elements are described above in particular combinations (e.g., embodiments, methods, examples, etc.), one of ordinary skill in the art will appreciate that each feature or element can be used alone or in any combination with the other features and elements. For example, as disclosed herein there may be a method described in association with a figure for illustrative purposes, and one of ordinary skill in the art will appreciate that one or more features or elements from this method may be used alone or in combination with one or more features from another method described elsewhere. A symbol ‘/’ (e.g., forward slash) may be used herein to represent ‘and/or’, where for example, ‘A/B’ may imply ‘A and/or B’. As used herein, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’ or indicate that something "does happen" or "can happen". In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a, UE, terminal, base station, RNC, or any host computer.

As described herein, “etc.” may refer to etcetera, which is intended to reference any other like element in a list, or reference some other element disclosed herein. For example, if a list has “a, b, c, etc.” and another list disclosed herein discloses “a, b, c, d, e” then it is intended that the “etc.” may refer to at least “d, e” or “etc.” may generally refer to other letters in the alphabet.

As described herein, "at least one of" may be interchangeable with "one or more of".

As described herein, reference of a configuration may mean that at some point a UE may receive a message that includes configuration information. In one instance, the UE may provide feedback after having received it. In one instance, the UE may request the message. In one instance, the message may be unrequested.

Embodiments and examples described herein are provided for illustration and may be explained in the context of a particular wireless access technology, standard, protocol, or generation (e.g., 5G/NR). Unless otherwise indicated, such description is not intended to be limiting to that specific technology. Rather, the disclosed techniques, apparatuses, systems, and methods are intended to be applicable, as appropriate, to any wireless communication technology, including present and future cellular generations (e.g., 2G, 3G, 4G/LTE, 5G/NR, 6G, 7G and beyond) and non-cellular wireless technologies (e.g., Wi-Fi/IEEE 802.11, Bluetooth, Zigbee, UWB, satellite, and other wireless access technologies), and to any combination thereof. Accordingly, references to particular air interfaces, bands, numerologies, frame structures, network architectures, nodes, or terminology associated with a specific standard are examples only, and are intended to encompass analogous or corresponding features in other wireless systems to the extent consistent with the principles disclosed herein.

What is claimed:

1. An access network (AN) node comprising:
a processor;
a transceiver; and
a communication interface operatively coupled to the processor; wherein:
the processor and the transceiver are configured to receive, from a user equipment (UE), a first message;
the processor and the communication interface are configured to forward, to a core network (CN) node, the first message directly via a service-based interface (SBI) interface using a Hypertext Transfer Protocol (HTTP) protocol;
the processor and the communication interface are configured to receive, from the CN node, a second message directly via the SBI interface using the HTTP protocol; and
the processor and the transceiver are configured to transmit the second message to the UE.

2. The AN node of claim 1, wherein the UE is one or more of an RG, a Fifth Generation (5G) RG, a station (STA), or a customer premises equipment (CPE).

3. The AN node of claim 1, wherein the CN node is a user plane function (UPF) node, and the SBI interface is an N3 interface.

4. The AN node of claim 1, wherein the CN node is an access and mobility management function (AMF) node, and the SBI interface is an N2 interface.

5. The AN node of claim 1, wherein the AN node and the CN node communicate using one of: Third Generation Partnership Project (3GPP) access, trusted non-3GPP access, or untrusted non-3GPP access.

6. The AN node of claim 1, wherein the HTTP protocol is one of: an HTTP/2 protocol or an HTTP/3 protocol.

7. An access and mobility management function (AMF) node comprising:
a processor;
a transceiver; and
a communication interface operatively coupled to the processor; wherein:
the processor and the transceiver are configured to receive, from a first access network (AN) node via a service-based interface (SBI)-based N2 interface, a first message in a first radio access technology (RAT)-specific format;
the processor is configured to translate the first message from the first RAT-specific format into a unified protocol;
the processor and the communication interface are configured to send, directly to a core network (CN) node, the translated first message via an SBI interface using a Hypertext Transfer Protocol (HTTP) protocol;
the processor and the communication interface are configured to receive, directly from the CN node via the SBI interface using the HTTP protocol, a second message in the unified protocol;
the processor is configured to translate the second message from the unified protocol into the first RAT-specific format; and
the processor and the transceiver are configured to send, to the first AN node via the SBI-based N3 interface, the translated second message.

8. The AMF node of claim 7, wherein the CN node is a Session Management Function (SMF) node, and the SBI interface using the HTTP protocol is an Nsmf interface.

9. The AMF node of claim 7, wherein the first AN node is one of: a Fifth Generation (5G)-AN node or a Sixth Generation (6G)-AN node.

10. The AMF node of claim 7, wherein the AMF node and the first AN node communicate using one of: Third Generation Partnership Project (3GPP) access, trusted non-3GPP access, or untrusted non-3GPP access.

11. The AMF node of claim 7, wherein the HTTP protocol is one of: an HTTP/2 protocol or an HTTP/3 protocol.

12. The AMF node of claim 7, wherein the first message and the second message are control plane messages.

13. The AMF node of claim 7, wherein:
the processor and the transceiver are further configured to receive, from a second AN node via a service-based interface (SBI)-based N2 interface, a third message in a second radio access technology (RAT)-specific format;
the processor is further configured to translate the third message from the second RAT-specific format into a unified protocol;
the processor and the communication interface are further configured to send, directly to a CN node, the translated third message via an SBI interface using a HTTP protocol;
the processor and the communication interface are further configured to receive, directly from the CN node via the SBI interface using the HTTP protocol, a fourth message in the unified protocol;
the processor is further configured to translate the fourth message from the unified protocol into the second RAT-specific format; and
the processor and the transceiver are further configured to send, to the second AN node via the SBI-based N2 interface, the translated fourth message.

14. The AMF node of claim 13, wherein the first AN node is a 3GPP AN node, and the second AN node is an untrusted non-3GPP AN node.

15. The AMF node of claim 13, wherein the first AN node is an untrusted non-3GPP AN node, and the second AN node is a 3GPP AN node.

16. A user plane function (UPF) node comprising:
a processor;
a transceiver; and
a communication interface operatively coupled to the processor; wherein:
the processor and the transceiver are configured to receive, from an access network (AN) node via a service-based interface (SBI)-based N3 interface, a first message in a radio access technology (RAT)-specific format;
the processor is configured to translate the first message from the RAT-specific into a unified protocol;
the processor and the communication interface are configured to send, directly to a core network (CN) node, the translated first message via an SBI interface using a Hypertext Transfer Protocol (HTTP) protocol;
the processor and the communication interface are configured to receive, directly from the CN node via the SBI interface using the HTTP protocol, a second message in the unified protocol;
the processor is configured to translate the second message from the unified protocol into the RAT-specific format; and
the processor and the transceiver are configured to send, to the first AN node via the SBI-based N3 interface, the translated second message.

17. The UPF node of claim 16, wherein the CN node is a protocol data unit (PDU) session anchor (PSA)-UPF, the SBI interface using the HTTP protocol is an SBI-based N9 interface, and the first message and the second message are user plane messages.

18. The UPF node of claim 16, wherein the first AN node is one of: a Fifth Generation (5G)-AN node or a Sixth Generation (6G)-AN node.

19. The UPF node of claim 16, wherein the UPF node and the first AN node communicate using one of: Third Generation Partnership Project (3GPP) access, trusted non-3GPP access, or untrusted non-3GPP access.

20. The UPF node of claim 16, wherein the HTTP protocol is one of: an HTTP/2 protocol or an HTTP/3 protocol.
